(19) United States
(12) Patent Application Publication
(10) Pub. No.: US 2026/0115682 A1
(43) Pub. Date: Apr. 30, 2026

(54) HYDROGEN REACTORS INCLUDING FLEXIBLE MEMBRANES

(71) Applicant: Massachusetts Institute of Technology, Cambridge, MA (US)

(72) Inventors: Mark Donahue, Littleton, MA (US); Erik Limpaecher, Concord, MA (US); Eric Morgan, Harvard, MA (US); Erin Looney, Newton, MA (US)

(73) Assignee: Massachusetts Institute of Technology, Cambridge, MA (US)

(21) Appl. No.: 19/009,927

(22) Filed: Jan. 4, 2025

Related U.S. Application Data
(60) Provisional application No. 63/618,270, filed on Jan. 5, 2024.

(51) Int. Cl. B01J 19/18; C01B 3/10

(52) U.S. Cl. CPC B01J 19/1893; C01B 3/10; B01J 2219/32408; C01B 2203/041

(57) ABSTRACT

In some embodiments, a reactor and/or related may generate pressurized hydrogen within an internal volume by combining water and a water reactive material. In some embodiments, the reactor may include a flexible porous membrane configured to contain water reactive material disposed in an internal volume. In some embodiments, the reactor may include a support configured to support a water reactive material in an internal volume.

### RELATED APPLICATIONS

This application claims priority under 35 U.S.C. § 119 (e) to U.S. Provisional Application No. 63/618,270 filed Jan. 5, 2024, which is incorporated herein by reference in its entirety for all purposes.

### GOVERNMENT LICENSE RIGHTS

This invention was made with government support under FA8702-15-D-0001 awarded by the U.S. Air Force. The government has certain rights in the invention.

### TECHNICAL FIELD

Disclosed embodiments are related to hydrogen reactors including flexible membranes.

### BACKGROUND

Hydrogen gas has been well recognized as an emission-free fuel holding promise for a more sustainable energy economy compared to fossil fuels. Oxidation-reduction reactions involving metals can produce hydrogen on-demand, eliminating the cost and safety concerns of storing hydrogen as a gas or liquid at high-pressure. Aluminum (Al), for example, has an energy density about two times greater than diesel fuel and forty times greater than lithium ion, and reacts with water to produce hydrogen.

### SUMMARY

In some embodiments, a reactor for producing hydrogen gas includes a housing including an internal volume and a flexible porous membrane disposed in the internal volume. The flexible porous membrane divides the internal volume into a first volume and a second volume, The reactor also includes a support configured to support a water reactive material in the first volume and an outlet formed in the housing. The outlet is in fluid communication with the first volume and is in fluid communication with the second volume through the flexible porous membrane.

In some embodiments, a method of producing hydrogen gas includes combining a water reactive material and a liquid in a first volume to produce hydrogen gas and a waste material in the first volume. The first volume is formed by a first portion of a housing and a flexible porous membrane. The method further includes diffusing the waste material across a flexible porous membrane from the first volume to a second volume formed by a second portion of the housing and the flexible porous membrane.

In some embodiments, a flexible reactor for producing hydrogen gas includes a flexible water impermeable membrane with an internal volume configured to contain a water reactive material and water to produce hydrogen in the internal volume. The flexible reactor also includes a flexible support sleeve, wherein the flexible water impermeable membrane is disposed in the flexible support sleeve, and wherein a tensile strength of the flexible support sleeve is greater than a tensile strength of the flexible water impermeable membrane in at least one direction to support a pressure of the produced hydrogen.

Other advantages and novel features of the present disclosure will become apparent from the following detailed description of various non-limiting embodiments of the disclosure when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present disclosure will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure. In the figures:

FIG. 1 is a cross-sectional view of a reactor according to one embodiment;

FIG. 2 is a schematic of a system including a reactor according to one embodiment; and

FIG. 3 is a method flow diagram of producing hydrogen using a reactor according to an embodiment.

### DETAILED DESCRIPTION

As described above, hydrogen may be used as an emission-free fuel source, but many conventional arrangements for generating hydrogen involve using reactors that are not well suited to remote applications. Such a reactor may be inconvenient, if not impossible to transport to remote locations due to its size, weight, and/or complexity. For example, such systems may be too large to transport or may take a long time to assemble on site prior to generating hydrogen. Given the above limitations, the Inventors have recognized the need for a mobile reactor that can be easily transported and used in any number of applications and environments. The Inventors have also appreciated the need for rapid deployment of a reactor in remote applications. Such a reactor may be assembled or prepared quickly on site to generate pressurized hydrogen on demand. This would allow a user to have access to usable fuel within minutes to power an associated system.

In view of the above, the Inventors have recognized the benefits associated with reactors designed to easily combine and react a desired amount of water reactive material (e.g. aluminum, sodium, etc.) with a liquid (e.g. water) within an internal volume to create on-demand pressurized hydrogen. Such a reactor may be reliable, simple to operate, and/or may be capable of being operated multiple times in a short time period. In some embodiments, a user may control an amount of water reactive material and/or water combined in the reactor to control a pressure and/or amount of hydrogen generated within the internal volume.

Without wishing to be bound by theory, waste materials may be produced during the above noted reactions including, for example, aluminum hydroxide. If uncontrolled, some conventional reactor designs can lead to the water reactive material becoming isolated from the water during a reaction due to the presence of waste materials accumulating adjacent to the water reactive materials either on a bottom interior surface of the reactor or locally around floating reactive material. Such isolation can lead to thermal runaway and/or other undesirable conditions during hydrogen production. Therefore, the Inventors have appreciated the benefits associated with transporting waste materials away from a water reactive material within an internal volume of a reactor during hydrogen production. For example, and without wishing to be bound by theory, transporting the waste materials away from the water reactive material may still allow localized heating of the reaction site while helping maintain an appropriate interface between the water reactive material and the water.

In view of the above, the Inventors have recognized the benefits associated with the use of flexible porous membranes to mediate the transport of waste material away from a water reactive material within an internal volume of a reactor. For example, in some embodiments, a reactor may include a housing with an internal volume. A flexible porous membrane may be positioned within the internal volume such that the flexible porous membrane divides the internal volume into a first volume and a second volume. For instances, in some embodiments, the flexible porous membrane may be positioned within the internal volume such that it is disposed within and extends across at least a portion of the internal volume between the first volume and second volume. As discussed further below, in some embodiments, the water reactive material may be contained within the first volume and waste material generated by the reaction, such as an aluminum hydroxide in some embodiments, may diffuse from the first volume through the pores of the flexible porous membrane into the second volume. Thus, the waste material may be transported away from water reactive material. This may aid in maintaining a desired interface and reaction kinetics between the water reactive material and liquid water within the reactor.

During operation of the reactors disclosed herein, and without wishing to be bound by theory, water reactive material and water within a first volume may be reacted to produce hydrogen gas and waste material. As the reaction progresses, waste material in the first volume may diffuse through the flexible porous membrane into the second volume. When hydrogen is needed, a user may flow hydrogen out of the internal volume through the outlet in the housing. The outlet may be in fluid communication with the first volume as well as the second volume through the first volume.

The flexible porous membranes used in the various embodiments disclosed herein may be provided with any appropriate size and shape capable of dividing an internal volume of a reaction into appropriate first and second volumes for reaction of a water reactive material in the first volume while permitting transport of waste material from the first volume to the second volume. For example, depending on the embodiment, a flexible porous membrane may have any appropriate shape including, but not limited to a pouch, bladder, sleeve, a planar construction, and/or any other appropriate shape. Further, the shape of the flexible porous membrane may be regular or irregular depending on the embodiment.

In some embodiments, it may be desirable to maintain a water reactive material separated from an underlying surface relative to a direction of gravity during operation. This may help to avoid trapping waste material between the water reactive material and the underlying surface. Thus, in some embodiments, a reactor may include a support configured to support the water reactive material spaced apart from an underlying surface during operation. For example, a support may be configured to support a water reactive material in a predetermined location within the first volume during operation. In some such embodiments, the support may be configured to hold the water reactive material off of an underlying bottom surface of the membrane relative to the support during operation, or to separate the water reactive material from side wall surfaces. In this regard, the water reactive material may be attached to the support in any desired configuration. Using a support may be beneficial to maintain the water reactive material off of the opposing bottom surface or side walls and may also allow for desirable mixing with water within the internal volume. For example, the support may hold the water reactive material away from any waste material which may accumulate on the underlying surface within the first and/or second volume. In some embodiments, the support may comprise a rigid support such as a rod, tube, perforated platform, and/or other rigid mechanical supporting structure. In other embodiments, the support may comprise a flexible support such as a tether, cable, wire, string, and/or any other appropriate flexible structure. In any case, it is contemplated that the support may comprise any non-reactive material that may be substantially inert relative to reaction with the water reactive materials disclosed herein. This may include, for example, appropriate plastics, rubbers, coated aluminum, stainless steel, and other appropriate materials rated for the reaction temperatures and other key criteria. Depending on the embodiment, the support may be attached to the housing at a first end portion and connected to the water reactive material at a second end portion opposite the first end portion. In some embodiments, the support is suspended from a top portion of the housing. For example, in some embodiments, the support may connect to a lid at a first end portion and to a water reactive material at a second end portion opposite the first end portion.

To provide appropriate reaction kinetics and diffusion of waste material away from a reaction interface between a water reactive material and the surrounding water within a reactor, it may be desirable to provide an appropriate volume ratio between the first and second volumes divided by a flexible porous membrane when the reactor is pressurized. Accordingly, in some embodiments, the second volume may be greater than the first volume in which a water reactive material is disposed when the reactor is pressurized. For example, a volume ratio of the second volume to the first volume may be greater than or equal to 20, 30, 40, 50, 60, 70, 80, 90, or other appropriate range. Correspondingly, the volume ratio of the second volume to the first volume may be less than or equal to 100, 90, 80, 70, 60, 50, 40, 30, or other appropriate range. Combinations of the above are also contemplated. For example, the volume ratio of the second volume to the first volume when the reactor is pressurized may be between 40 and 80. The volume ratio of the second volume to the first volume when the reactor is pressurized may be between 20 and 100. Of course other combinations of the above ranges may also be used. Also, while the above ranges are beneficial, in other embodiments other volume ratios may also be used as the disclosure is not so limited.

In some embodiments, a housing of a reactor may be flexible. For example, the housing may include a flexible water impermeable membrane configured to contain the water reactive material and water to produce hydrogen within an internal volume formed by the flexible water impermeable membrane. Similar to the above embodiments, a flexible porous membrane may be disposed within the flexible water impermeable membrane to form first and second volumes within the internal volume. The housing may further comprise a flexible outer support sleeve that the flexible water impermeable membrane is disposed within such that the outer support sleeve at least partially surrounds and supports pressure applied to the water impermeable membrane by pressurized gas contained within the water impermeable membrane. Any appropriate shape for the flexible water impermeable membrane may be used including, for example, pouches, tubes, and/or any other appropriate shape capable of being formed by the flexible water impermeable membrane and capable of containing a reaction therein. As will be discussed later, a tensile strength of the outer support sleeve may be greater than a tensile strength of the water impermeable membrane in at least one direction to support a pressure of the produced hydrogen. The outer support sleeve and the flexible water impermeable membrane may be further configured to withstand a temperature within the internal volume during operation due to reaction of the water reactive material therein. In this regard, the outer support sleeve may provide support to the water impermeable membrane while the flexible water impermeable membrane contains the liquid and gas contained therein. For example, the outer support sleeve may limit expansion of the water impermeable membrane during the reaction. It is appreciated that the outer support sleeve may comprise any material configured to withstand a temperature and/or pressure within the reactor.

Due to the flexible membranes and the flexible outer support sleeve, it is appreciated that at least some of the reactors disclosed herein may be flexible. Such flexible reactors offer benefits such as being collapsable which may result in easier transport, storage, and deployment. For example, in some embodiments, it is contemplated that a reactor may be rolled up and stored within a backpack to transport to a remote location. To deploy the reactor, the reactor may be unrolled and prepared to be used within minutes to generate hydrogen as previously described.

The overall size of the flexible reactors disclosed herein may correspond to any desired reaction volume. In some embodiments, the internal volume of the reactor when pressurized may be greater than or equal to 0.1 L, 0.2 L, 0.3 L, 0.4 L, 0.5 L, 0.6 L, 0.7 L, 0.8 L, 0.9 L, or other appropriate range. The internal volume of the reactor may be less than or equal to 20 L, 1 L, 0.9 L, 0.8 L, 0.7 L, 0.6 L, 0.5 L, 0.4 L, 0.3 L, 0.2 L, or other appropriate range when pressurized. Combinations of the above are also contemplated. For example, the flexible reactor may have a volume between or equal to 0.3 L and 0.6 L when pressurized. The flexible reactor may have a volume between or equal to 0.1 L and 1 L when pressurized. In some embodiments, the reactor may have a volume between or equal to 0.1 L and 20 L when pressurized. While the above volumes may be desirable for smaller and/or transportable applications, in other embodiments, the reactors disclosed herein may have larger internal volumes greater than those noted above as the disclosure is not so limited.

It should be understood that the flexible porous membrane may comprise any appropriate material and/or pore size capable of containing a water reactive material therein while permitting the diffusion of waste materials, such as aluminum hydroxide or other reactants produced during a reaction with water, through the pores of the flexible porous membrane. The material may also be selected to withstand the reaction temperatures between the water and reactant which may be greater than the average temperature of the surrounding water during operation. It should be understood that the pores may be provided in a number of different forms including, for example, an open porous network of interconnected pores forming a tortuous path through the flexible porous membrane. Alternatively, in some embodiments, membranes with open pores extending directly through the flexible porous membrane may be used as the disclosure is not limited to a particular type of porous membrane. Appropriate types of membranes may include non-woven membranes, woven membranes, engineered membranes, and/or any other appropriate types of construction exhibiting the desired combination of properties. In some embodiments, the flexible porous membrane may comprise nylon, polyether-polyurea copolymers (e.g., Spandex), meta-aramids (e.g., Nomex), and/or any appropriate material as the disclosure is not so limited.

In some embodiments, the flexible porous membrane may have an average porosity greater than or equal to 50%, 60%, 70%, or other appropriate ranges. In some embodiments, the flexible porous membrane may have an average porosity less than or equal to 80%, 70%, 60%, or other appropriate ranges. Combinations of the above are contemplated. For example, in some embodiments the flexible permeable membrane may have an average porosity between or equal to 50% and 80%. It is contemplated that average porosity may be measured using mercury porosimetry.

To provide an appropriate diffusion of a waste material across a flexible porous membrane, in some embodiments, it is contemplated that the flexible porous membrane may have an average pore size that is greater than or equal to 1 μm, 5 μm, 10 μm, 25 μm, 50 μm, 100 μm, 150 μm, 200 μm, 250 μm, 300 μm, 350 μm, 400 μm, 450 μm, 500 μm, 550 μm, or other appropriate ranges. The average pore size may also be less than or equal to 1000 μm, 800 μm, 600 μm, 550 μm, 500 μm, 450 μm, 400 μm, 350 μm, 300 μm, 250 μm, 200 μm, 150 μm, 100 μm, 50 μm, 25 μm, 10 μm, 5 μm, or other appropriate ranges. Combinations of the above are contemplated. For example, in some embodiments the flexible permeable membrane may have an average pore size between or equal to 100 μm and 400 μm. In other embodiments, the flexible porous membrane may have an average pore size between or equal to 1 μm and 600 μm. In other embodiments, the flexible porous membrane may have an average pore size between or equal to 1 μm and 1000 μm. It is contemplated that average pore size may be measured using mercury porosimetry.

The Inventors have appreciated that during a reaction, an internal volume of the reactors disclosed herein may experience high temperatures and/or high pressures. For example, depending on the pressure within the internal volume, temperatures within the internal volume may be between or equal to 100° C. and 150° C. or other appropriate temperature range. Additionally, pressures within the reactor may be approximately equal to 0.5 MPa. However, other larger pressures and temperatures may be present in a reactor in other embodiments. Thus, the flexible porous membrane, flexible water impermeable membrane, and the flexible outer support may be made of appropriate materials and may be sized and shaped such that the reactor is configured to withstand these elevated temperatures and pressures during operation (e.g., due to the reaction, increased water temperature, etc.). It is appreciated that in some embodiments, the flexible porous membrane and water impermeable membrane may be partially exposed to the water and partially exposed to the head space within the internal volume. As such, steam may condense on the flexible porous membrane and water impermeable membrane. Thus, in some embodiments, the flexible porous membrane and water impermeable membrane may be configured to withstand high temperatures of the steam present within the head space during operation.

It is contemplated that the flexible water impermeable membrane may be any appropriate material suited to withstand the pressure and/or temperature of the reaction. For example, the water impermeable membrane may comprise rubber, latex, high temperature flexible plastics, or any other appropriate material as the disclosure is not so limited. The water impermeable membrane may be configured to contain the liquid in the internal volume, hydrogen gas, and/or waste material produced by the reaction. For example, the water impermeable membrane may contain the liquid, hydrogen, and/or waste materials within the inner volume without allowing any diffusion, leaks, etc. from the inner volume. The flexible water impermeable membrane may be less rigid than the flexible outer support sleeve and may have a tensile strength in any direction that is less than a tensile strength of the outer support sleeve. Similar to the discussion above, in some embodiments, the flexible water impermeable membrane may be partially exposed to water and partially exposed to steam within a head space of the internal volume. Thus, in some embodiments, the flexible water impermeable membrane may be configured to withstand high temperatures of the steam within the head space.

As mentioned above, it should be understood that the outer support sleeve may comprise any appropriate material capable of withstanding the pressure and/or temperature within the internal volume. For example, in some embodiments the flexible support sleeve may comprise a woven material. In other embodiments, the support sleeve may comprise a non-woven material. The ends of the sleeve may be sealed in any appropriate fashion including the use of end caps and/or the sleeve may be sewn, woven, or otherwise fabricated to support the internal pressure of the reactor. Depending on the embodiment, it is contemplated that the outer support sleeve can comprise a para-aramid (e.g., Kevlar), ultra-high molecular weight polyethylene, and/or any other appropriate material that is less extensible than the flexible water impermeable membrane as the disclosure is not so limited. In some embodiments, the outer support sleeve may comprise a materials that is resistant to ultra-violet (UV) light.

It is also contemplated that a tensile strength and yield strength of the outer support sleeve may be greater than a tensile strength and yield strength of the flexible water impermeable membrane and/or the flexible porous membrane in at least one direction to support a pressure of the produced hydrogen. For example, the outer support sleeve may have a tensile strength and yield strength greater than the flexible water impermeable membrane and/or the flexible porous membrane in an axial dimension, a transverse (e.g. circumferential) dimension, and/or a combination of both. Additionally, it is contemplated that the outer support sleeve may be less elastic than the flexible porous membrane and/or the flexible impermeable membrane. This may be beneficial to provide support to the flexible impermeable membrane during the reaction. For example, the outer support sleeve may support the pressures applied within the internal volume of the flexible water impermeable membrane.

While the disclosure thus far has contemplated a flexible reactor (e.g. the housing is a first flexible pouch, and the flexible porous membrane forms a second flexible pouch disposed in the first flexible pouch) it is also contemplated that the housing may comprise a rigid outer support as the disclosure is not so limited. The rigid outer support may be beneficial to support the flexible water impermeable membrane at elevated pressures and/or temperatures. The rigid outer support may comprise any appropriate material (e.g. stainless steel, coated aluminum, rigid plastic, high temperature plastic, composites, etc.) as the disclosure is not limited. It may be beneficial to provide a coating (e.g. epoxy, polymer, etc.) on an internal surface of the rigid outer support to avoid contact with reactive materials disposed therein.

The reactors disclosed herein may, in some embodiments, provide a simple and convenient way of generating pressurized hydrogen. Such hydrogen may be used with an associated system configured to utilize hydrogen fuel. For example, such a system may include a fuel cell, sensors, electronics, an/or any system as the disclosure is not so limited. Additionally or alternatively, the generated hydrogen may be stored in an external vessel. The Inventors have also recognized that such a reactor may itself be utilized as a storage device. In such an embodiment, the reactor may store pressurized hydrogen for later use in any desired system utilizing hydrogen as a fuel source.

In certain embodiments, and as explained in greater detail herein, the water reactive material may comprise aluminum or an alloy thereof. Without wishing to be bound by theory, water and aluminum react to produce hydrogen gas according to either of the following exothermic reactions shown in reactions (1) and (2):

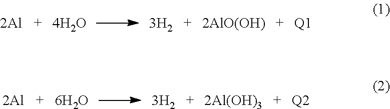

where Q1 and/or Q2 are heat.

Depending on the embodiment, the water reactive material may comprise any appropriate shape and/or form. For example, the material may comprise pellets, balls, powders, particles, chunks of material, and/or slurries. The water reactive material may be regularly shaped, such as spherical, or may be irregularly shaped chunks. The size of the water reactive material may be uniform or varied. Alternatively, the water reactive particles may be provided in a more continuous form, such as a powder with any appropriate size distribution for a desired application. Depending on the embodiment, the size distribution may be substantially uniform, such that the size of particles within the powder are substantially homogeneous.

In some embodiments, the water reactive material may have an average maximum transverse dimension that is greater than or equal to 100 μm, 250 μm, 500 μm, 1 mm, 5 mm, 1 cm, 5 cm, or other appropriate ranges. The average maximum transverse dimension may be less than or equal to 10 cm, 8 cm, 5 cm, 2 cm, 1 cm, 5 mm, 1 mm, 500 μm, 250 μm, or other appropriate ranges. Combinations of the above are contemplated. For example, in some embodiments, the water reactive material may have an average maximum transverse dimension between or equal to 100 μm and 10 cm. Controlling the average size of the water reactive material may be advantageous to dispense the material into a reaction chamber at a desired rate. Additionally or alternatively, controlling the size of the water reactive material may be advantageous to minimize clogging and/or jamming while dispensing the material into the reaction chamber.

As mentioned above, hydrogen gas is produced by exposing water reactive material to water. In some such embodiments, the rate and amount of hydrogen gas produced can be controlled by modifying the type and concentration of certain water reactive materials. In some embodiments, the water reactive material comprises aluminum, as described above in relation to reactions (1) and (2). However, other metals may also be used depending on the particular embodiment. Non-limiting examples of water reactive materials that may be used are aluminum, lithium, sodium, magnesium, zinc, boron, beryllium, alloys thereof, and/or mixtures thereof.

The water reactive materials, in some embodiments, comprise an activating composition that is permeated into the grain boundaries and/or subgrain boundaries of the reactant (e.g. aluminum) to facilitate its reaction with water. For example, a reactant may include aluminum combined with gallium and/or indium. In some instances, the activating composition may be a eutectic, or close to eutectic composition, including for example a eutectic composition of gallium and indium. In one such embodiment, the activating composition may comprise gallium and indium where the portion of the activating composition may have a composition of about 70 wt. % to 80 wt. % gallium and 20 wt. % to 30 wt. % indium, though other weight percentages are also possible. Without wishing to be bound by theory, gallium and/or indium may permeate through one or more grain boundaries and/or subgrain boundaries of the reactant (e.g., aluminum).

In certain embodiments, the activating composition may be incorporated into an alloy with the reactant. A metal alloy may comprise any activating composition in any of a variety of suitable amounts. In some embodiments, for example, the metal alloy comprises greater than or equal to 0.1 wt. % of the activating composition, greater than or equal to 1 wt. %, greater than or equal to 5 wt. %, greater than or equal to 15 wt. %, greater than or equal to 30 wt. %, or greater than or equal to 45 wt. % of the activating composition based on the total weight of the metal alloy. In certain embodiments, the metal alloy comprises less than or equal to 50 wt. %, less than or equal to 40 wt. %, less than or equal to 30 wt. %, less than or equal to 20 wt. %, less than or equal to 10 wt. %, less than or equal to 5 wt. %, or less than or equal to 1 wt. % of the activating composition, based on the total weight of the metal alloy. Combinations of the above recited ranges are also possible (e.g., the metal alloy comprises greater than or equal to 0.1 wt. % and less than or equal to 50 wt. % of the activating composition based on the total weight of the metal alloy, the metal alloy comprises greater than or equal to 1 wt. % and less than or equal to 10 wt. % of the activating composition based on the total weight of metal alloy). In some embodiments, the metal alloy the activating composition is incorporated into may be an aluminum alloy, though other water reactive materials may also be used. Other ranges are also possible.

The Inventors have also realized that hydrogen produced within the reaction chamber can be used for any number of different uses. The produced hydrogen may also be stored under high or low pressure in tanks, canisters, and/or other appropriate pressurized gas containers. The produced hydrogen gas may also be used to produce electricity and/or mechanical work (e.g., via a fuel cell, turbine, and/or internal combustion engine). Thus, the disclosed systems and corresponding produced hydrogen may be used for any number of different applications. In some specific embodiments, hydrogen gas can be used to fill removeable hydrogen canisters that can be integrated into systems such as fuel cells, unmanned aerial vehicles, ground vehicles, ground sensors, cookstoves, or any other appropriate system. The Inventors have realized that low pressure hydrogen can be fed directly into systems to provide electrical power. For example, low pressure hydrogen may be used for continuous power generation for remote sensors, remote command posts, remote charging, or other remote and/or unattended applications. Low pressure hydrogen may also be directly supplied to low-pressure fuel cells.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

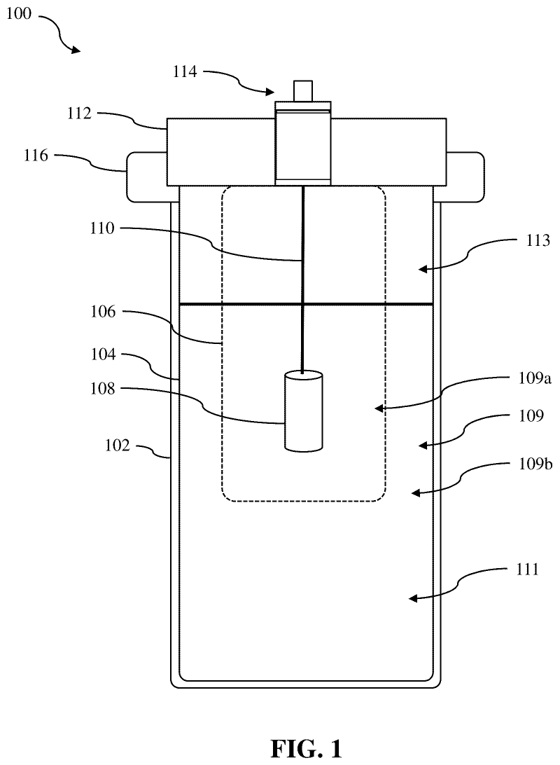

FIG. 1 illustrates one embodiment of a reactor. As seen in the figure, according to some embodiments, a reactor 100 for producing hydrogen gas may include a housing comprising a flexible outer support sleeve 102 and a flexible water impermeable membrane 104 disposed therein. The flexible outer support sleeve 102 may be sized and shaped to at least partially surround the flexible water impermeable membrane 104. In some embodiments, the flexible outer support sleeve 102 may be sewn (e.g., fabricated or woven) to support an internal pressure of the reactor. In the depicted embodiment, the flexible water impermeable membrane 104 and the flexible outer support sleeve 102 are shaped as nested pouches with similar sizes and shapes. However, other constructions may also be used as noted above. The flexible outer support sleeve 102 and the flexible water impermeable membrane 104 may be connected to a lid 112 or otherwise sealed to form an internal volume 109 disposed within the flexible water impermeable membrane 104. In the depicted embodiment, a flexible porous membrane 106 may be disposed within the internal volume 109 formed within the flexible water impermeable membrane 104. Thus, the flexible water impermeable membrane 104 and the flexible outer support sleeve 102 at least partially surround the flexible porous membrane 106. In some embodiments, the flexible porous membrane 106 divides the internal volume 109 into a first volume 109a and a second volume 109b.

In some embodiments, the flexible porous membrane 106 may be connected to or otherwise sealed to the lid 112. It is contemplated that the flexible porous membrane may comprise any suitable size and/or shape as the disclosure is not so limited. In the depicted embodiment, the flexible porous membrane 106 is shaped as a pouch and extends from the lid 112 into the internal volume 109. The flexible porous membrane may be disposed in the internal volume 109 such that the flexible porous membrane 106 divides the internal volume 109 into a first volume 109a and a second volume 109b which at least partially surrounds the first volume. In some embodiments, the first volume 109a may be at least partially formed by a first portion of the lid 112 and the flexible porous membrane 106. The second volume 109b may be at least partially formed by a second portion of the lid 112, the flexible porous membrane 106, and a portion of the flexible water impermeable membrane 104. Thus, in some embodiments a reactor may comprise a flexible porous pouch disposed in an internal volume 109 at least partially formed by a flexible water impermeable pouch nested within a flexible outer pouch configured to support pressure applied to the flexible water impermeable pouch during a reaction. In some embodiments, at least a portion of the flexible porous membrane 106 may be disposed in the water 111 contained in the internal volume 109 such that a water reactive material 108 contained within the flexible porous membrane 106 is exposed to the water 111.

In some embodiments, the reactor may comprise a lid 112 that may form at least a portion of the housing. For example, the flexible outer support sleeve 102 and the flexible water impermeable membrane 104 may be coupled, and optionally sealed, to the lid 112 such that an internal portion of the lid 112 and the flexible water impermeable membrane 104 form the internal volume 109. The lid 112 may have any appropriate size and shape and may be made from any non-reactive material capable of withstanding the temperatures, pressures, and reactants contained within the internal volume 109 during operation. For example, the lid 112 may comprise plastic, stainless steel, coated aluminum, or any other appropriate material. The lid may further be configured to form a seal with the flexible water impermeable membrane 104 such that the internal volume 109 is configured to contain the generated hydrogen gas without leaking.

It is contemplated that in some embodiments, the lid 112 may be selectively coupled to the rest of the housing in any desired manner (e.g. friction fit, press fit, threaded coupling, hose clamp, end clamp, or any other desired coupling). For example, in some embodiments the lid may have a threaded fastener formed on an exterior surface thereof such that the lid 112 may mate with a corresponding surface at a mating top portion 116 of the housing connected to the flexible water impermeable membrane 104. This may be beneficial to rapidly deploy the reactor because loading a water reactive material 108 and securing the lid may, in some embodiments, be accomplished at substantially the same time. For example, the flexible porous membrane 106 can be lowered into the internal volume 109 while securing the lid 112 to the rest of the housing. In this regard, the lid 112 is secured to the housing as the flexible porous membrane 106 containing the water reactive material 108 is combined with the water 111 in the internal volume 109. A selective connection between the lid 112 and the rest of the housing may be beneficial to allow access to the internal volume of the reactor to add water and/or water reactive material prior to a reaction. It may also be beneficial to allow access to the internal volume after the reaction is complete in order to clean out the reactor and prepare for another reaction.

The flexible porous membrane may be configured to contain a water reactive material 108 such that the water reactive material does not directly contact an interior surface of the housing. Additionally, in some embodiments, water 111 contained within the internal volume 109 may diffuse through the flexible porous membrane 106 and react with the water reactive material 108 in the first volume 109a to generate hydrogen gas. To further avoid contact between a water reactive material 108 and other surrounding surfaces, in some embodiments, the reactor 100 may also include a support 110 configured to support the water reactive material 108 at a predetermined location within the internal volume 109. In some embodiments, support 110 attaches to the lid 112 or other appropriate portion of the reactor 100 at a first end portion and to the water reactive material 108 at a second end portion. The support 110 may have an appropriate size and shape to support the water reactive material 108 at the predetermined location during a reaction between the water reactive material 108 and water 111 disposed in the reactor 100 during operation. Depending on the embodiment, the support 110 may be rigid or flexible as noted previously above.

In some embodiments, hydrogen gas may diffuse through flexible porous membrane 106 such that the hydrogen is contained in both the first and second volumes, 109a and 109b. A pressure of the generated hydrogen may depend on an amount of hydrogen generated by the reaction and an amount of head space 113 available in the internal volume. As pressure accumulates within the internal volume 109, the flexible outer support sleeve 102 may provide rigidity and support to the flexible water impermeable membrane 104.

In some embodiments, the reactor further comprises an outlet 114 formed in the lid 112 or other portion of the reactor 100. The outlet 114 may be in fluid communication with the internal volume 109. Depending on the embodiment, the outlet 114 may include a simple opening, a valved connection, and/or any other desired type of outlet capable of providing a flow of hydrogen gas to a desired operation. For example, the outlet 114 may be in selective fluid communication with the first volume 109a. The outlet 114 may also be in selective fluid communication with the second volume 109b through the first volume. Depending on the embodiment, the outlet 114 may be used to flow hydrogen out of the internal volume 109. In some embodiments, outlet 114 may include an isolation valve to selectively permit or prevent the flow of hydrogen out of the internal volume 109 from the reactor 100. It is also contemplated that in some embodiments, outlet 114 may comprise a quick-connect to rapidly couple the outlet to an associated system. By connecting and disconnecting quickly, the reactor may mitigate inadvertently flowing hydrogen gas to the atmosphere.

In some embodiments, the flexible porous membrane 106 may be connected to the housing adjacent to an opening in the housing. In the depicted embodiment, the flexible porous membrane 106 is located adjacent to the outlet 114. The flexible porous membrane may be configured to allow the outlet 114 to be in fluid communication with the first volume 109a and in fluid communication with the second volume 109b through the first volume. As mentioned above, such a configuration may be beneficial to flow hydrogen out of the internal volume 109. For example, as hydrogen is siphoned through the outlet, hydrogen located within the first volume 109a may flow through the outlet 114. Additionally or alternatively, hydrogen located in the second volume 109b may flow through the flexible porous membrane 106 prior to being siphoned through the outlet 114. Thus, all hydrogen produced by the reaction can flow from the internal volume 109 to an associated system (e.g. fuel cell, storage canister, stove, equipment, etc.).

Due to the flexible nature of the housing and the flexible porous membrane 106 in some embodiments, the reactor 100 may be collapsable. To transport the reactor, a user may roll up, fold, bend, or otherwise collapse the reactor in order to decrease its size. The reactor can be transported by a user with relative ease. For example, a user may store the reactor in a backpack to transport the reactor to a remote location. Once at the desired location, the reactor may be unrolled and prepared for use within minutes.

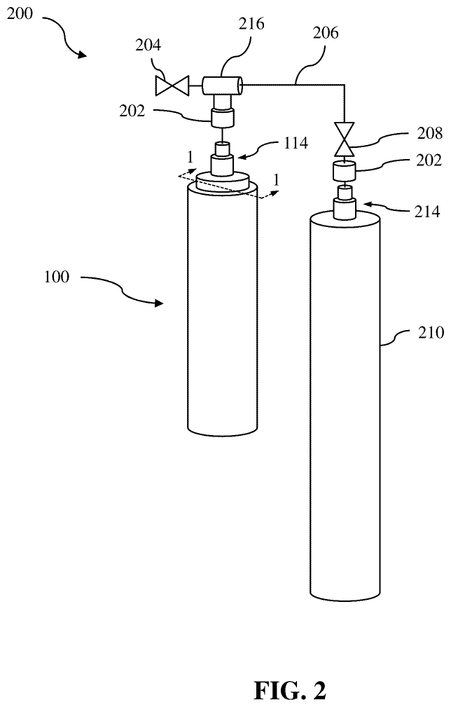

FIG. 2 illustrates a system 200 configured to utilize a reactor 100 as a hydrogen fuel source. In the illustrated embodiment, reactor 100 comprises an outlet 114 formed in a housing and in fluid communication with an internal volume of the reactor 100. The outlet 114 is configured to flow hydrogen out of the internal volume of the reactor which may allow the reactor to be used as a fuel source for an associated system using hydrogen gas as fuel. Depending on the embodiment, the outlet 114 may comprise any appropriate outlet, fitting, connector, coupling, and/or material as the disclosure is not so limited.

In the depicted embodiment, outlet 114 is connected to a three-way connector 216 (e.g., a tee) via a connector 202. This connection fluidly couples reactor 100 to hydrogen conduit 206 and establishes a hydrogen flow path between the reactor 100 and a system 210 that intakes hydrogen generated within reactor 100. Depending on the embodiment, system 210 may be any system that utilizes hydrogen such as a hydrogen fuel cell, a storage canister, a stove, various sensors, a pneumatic piston, or any other appropriate system as the disclosure is not so limited. The hydrogen conduit may comprise any appropriate configuration (rigid piping, flexible tubing, etc.) and/or material (steel, copper, plastic, rubber, metal alloy, etc.) configured to flow hydrogen as the disclosure is not so limited.

In some embodiments, a safety valve may be located along the hydrogen flow path. For example, in the illustrated embodiment, a safety valve 204 is connected to an outlet of three-way connector 216 such that the safety valve is in fluid communication with the hydrogen flow path. The safety valve may be configured to relieve pressure within the hydrogen flow path during operation by opening if a pressure of a flow of hydrogen within the system exceeds a maximum threshold pressure. Accordingly, safety valve 204 may mitigate over pressurizing the system which could lead to failure of the system. It is contemplated that safety valve 204 may be any appropriate safety valve and may be in fluid communication with the hydrogen flow path at any point along the hydrogen flow path as the disclosure is not so limited.

In the depicted embodiment, system 210 comprises an inlet 214 configured to flow hydrogen into the system 210. The inlet may connect to hydrogen conduit 206 via a connector 202 which fluidly couples system 210 to the hydrogen flow path, allowing system 210 to intake hydrogen from the reactor 100. In some embodiments, hydrogen conduit 206 comprises an isolation valve 208 disposed along the hydrogen conduit prior to connecting to system 210. The isolation valve may be configured to selectively isolate system 210 from the hydrogen flow path which may be beneficial to mitigate flowing hydrogen to an external environment. In some embodiments, a pressure regulator (not shown) may be disposed along the hydrogen conduit prior to connecting to system 210 to reduce a pressure of a flow of hydrogen to be at or below a desired pressure. This may be beneficial for using hydrogen from reactor 100 with a systems having a lower pressure rating such as fuel cells.

While in the figure the isolation valve 208 is shown adjacent to a connection between hydrogen conduit 206 and the system 210, the isolation valve may be located at any point along the hydrogen conduit. For example, the isolation valve may be located closer to reactor 100. Additionally or alternatively, system 200 may include any number and/or arrangement of isolation valves to provide desired control over the flow of hydrogen. System 200 may also comprise a quick connect located at an outlet of reactor 100 and/or at an inlet to system 210. The quick connect may be beneficial to minimize losing hydrogen to a surrounding environment when connecting system 210 to the hydrogen flow path.

While both the isolation valve 208 and quick connect fittings are discussed above, it is contemplated that in some embodiments, the quick connect comprises an internal isolation valve. For example, disconnecting inlet 214 from connector 202 may automatically stop a flow of hydrogen. Similarly, disconnecting the outlet 114 from connector 202 may automatically stop a flow of hydrogen from the internal volume of the reactor through the outlet 114. Thus, in such an embodiment, it may not be necessary to include a separate isolation valve.

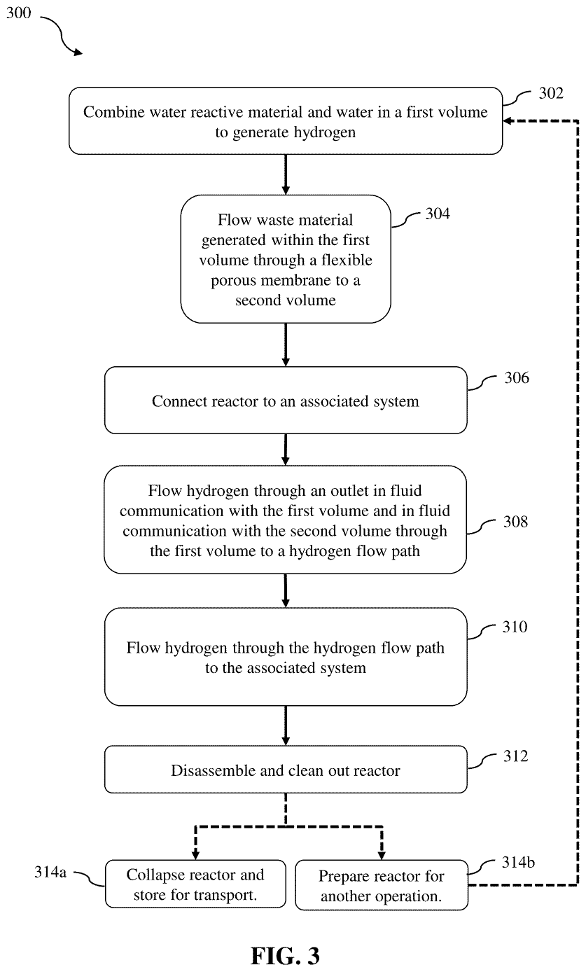

FIG. 3 illustrates a method flow diagram 300 for using a reactor to generate hydrogen according to one embodiment using any of the reactors disclosed herein. At step 302, a water reactive material 108 is combined with water 111 within the first volume to generate hydrogen gas. The water reactive material may be contained within the flexible porous membrane 106, and in some embodiments may be supported at a predetermined position within the first volume spaced apart from an underlying surface such as a flexible water impermeable membrane and/or a flexible porous membrane. It is contemplated that combining the water reactive material and water may include placing the flexible porous membrane 106 which contains the water reactive material 108 into the water 111 within the internal volume 109. In some embodiments, it is contemplated that combining the water reactive material 108 with the water 111 may coincide with securing a lid 112 to the reactor housing. Due to the fixed internal volume, hydrogen generated within the internal volume self-pressurizes the reactor to produce hydrogen within a predetermined pressure range based on a size of the reactor as well as an amount of water reactive material and water contained within the volume. Combining the water reactive material and water may generate waste material within the first volume 109a in addition to generating hydrogen gas therein.

Depending on the configuration of a flexible porous membrane, in some embodiments, the waste material may diffuse through the flexible porous membrane into the second volume 109b as seen in step 304. In some embodiments, waste material, such as aluminum hydroxide in some instances, may simply diffuse through the membrane from the first volume 109a into the second volume 109b. However, in some embodiments the pores of the flexible porous membrane 106 may be larger and at least a portion of the waste material may be deposited in and partially obstruct the pores within the flexible porous membrane 106 and function as a filter medium present in the pores of the flexible porous membrane 106 while still permitting the waste material to diffuse through the flexible porous membrane 106 from the first volume 109a to the second volume 109b at a desired rate.

At step 306, the reactor may be connected to an associated system 210 such that the system is placed in fluid communication with an outlet of the reactor. Alternatively, it is contemplated the hydrogen may be stored within the reactor prior to connecting the reactor to a system. For example, a user may desire to utilize the reactor as a storage vessel. When hydrogen fuel is desired, in some embodiments, the reactor may be connected directly to the associated system 210. In other embodiments, the reactor may be coupled to various conduits and valves to provide a hydrogen flow path between the reactor 100 and the associated system 210.

At step 308, hydrogen may flow out of the internal volume 109 of the reactor. Outlet 114 may be in fluid communication with the first volume 109a and in fluid communication with the second volume 109b through the first volume. Such a configuration may allow hydrogen within the internal volume to flow out of the reactor. Prior to flowing hydrogen out of the reactor, an isolation valve 208 may be manipulated to open a hydrogen flow path between the reactor 100 and the associated system 210. At step 310, hydrogen may flow through the hydrogen flow path to the associated system 210.

At step 312, the reactor may be disassembled by removing the lid 112 to access the internal volume 109. The reactor may be cleaned out to prepare for another reaction. Such a cleanout process may include removing waste material, water, and/or water reactive material from the internal volume.

Next, a user may decide to store the reactor for later use and/or transport as at step 314a. This may include rolling up or otherwise collapsing a flexible reactor, though again, the use of rigid reactors is also contemplated. Alternatively, a user may wish to produce more hydrogen. In this case, a user may prepare the reactor for another reaction as at step 314b. This may include adding more water to the inner volume and/or placing additional water reactive material within the reactor. Therefore, the disclosed reactors can be used either a single time and/or may be used multiple times in a relatively short period of time to produce a desired amount of hydrogen.

The embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A reactor for producing hydrogen gas, the reactor comprising:
a housing including an internal volume;
a flexible porous membrane disposed in the internal volume, wherein the flexible porous membrane divides the internal volume into a first volume and a second volume;
a support configured to support a water reactive material in the first volume;
an outlet formed in the housing, wherein the outlet is in fluid communication with the first volume, and wherein the outlet is in fluid communication with the second volume through the flexible porous membrane.

2. The reactor of claim 1, wherein the support is a flexible tether.

3. The reactor of claim 1, further comprising the water reactive material disposed in the first volume and attached to the support.

4. The reactor of claim 3, further comprising water disposed in the internal volume

5. The reactor of claim 1, wherein the housing is a flexible water impermeable membrane.

6. The reactor of claim 5, wherein the housing further comprises a flexible support sleeve, wherein the flexible water impermeable membrane and the flexible porous membrane are disposed in the flexible support sleeve, wherein a tensile strength of the flexible support sleeve is greater than a tensile strength of the flexible porous membrane and the flexible water impermeable membrane in at least one direction.

7. The reactor of claim 1, wherein the housing is a first flexible pouch, and the flexible porous membrane forms a second flexible pouch disposed in the first flexible pouch.

8. The reactor of claim 1, further comprising a safety vent in fluid communication with the outlet, wherein the safety vent is configured to vent gas from the internal volume when a pressure of the internal volume is greater than a threshold pressure.

9. The reactor of claim 1, wherein a volume ratio of the first volume to the second volume during gas generation is greater than or equal to 20.

10. The reactor of claim 1, wherein an average pore size of the flexible porous membrane is between or equal to 1 μm and 600 μm.

11. The reactor of claim 1, wherein the water reactive material includes at least one selected from the group of aluminum, sodium, magnesium, zinc, boron, beryllium, and alloys thereof.

12. The reactor of claim 1, wherein the water reactive material is an alloy of aluminum, gallium, and indium.

13. A method of producing hydrogen gas, the method comprising:
combining a water reactive material and a liquid in a first volume to produce hydrogen gas and a waste material in the first volume, wherein the first volume is formed by a first portion of a housing and a flexible porous membrane;
diffusing the waste material across a flexible porous membrane from the first volume to a second volume formed by a second portion of the housing and the flexible porous membrane.

14. The method of claim 13, wherein the flexible porous membrane is disposed in an internal volume of a housing, wherein the flexible porous membrane divides the internal volume into the first volume and the second volume.

15. The method of claim 14, wherein the housing comprises a flexible water impermeable membrane, wherein the flexible porous membrane is disposed in the flexible water impermeable membrane.

16. The method of claim 15, wherein the housing further comprises a flexible support sleeve, wherein the flexible porous membrane and the flexible water impermeable membrane are disposed in the flexible support sleeve, and wherein a tensile strength of the flexible support sleeve is greater than a tensile strength of the flexible porous membrane and the flexible water impermeable membrane in at least one direction.

17. The method of claim 16, further comprising flowing hydrogen gas through an outlet in fluid communication with the first volume, wherein the outlet is in fluid communication with the second volume through the flexible porous membrane.

18. The method of claim 17, wherein the water reactive material includes at least one selected from the group of aluminum, sodium, magnesium, zinc, boron, beryllium, and alloys thereof.

19. A flexible reactor for producing hydrogen gas, the reactor comprising:
a flexible water impermeable membrane with an internal volume configured to contain a water reactive material and water to produce hydrogen in the internal volume; and
a flexible support sleeve, wherein the flexible water impermeable membrane is disposed in the flexible support sleeve, and wherein a tensile strength of the flexible support sleeve is greater than a tensile strength of the flexible water impermeable membrane in at least one direction to support a pressure of the produced hydrogen.

20. The reactor of claim 19, further comprising:
a flexible porous membrane disposed in the internal volume, wherein the flexible porous membrane divides the internal volume into a first volume and a second volume.

21. The reactor of claim 20, further comprising a support configured to support the water reactive material in the first volume.

22. The reactor of claim 21, further comprising the water reactive material disposed in the first volume.

23. The reactor of claim 22, further comprising an outlet, wherein the outlet is in fluid communication with the first volume, and wherein the outlet is in fluid communication with the second volume through the flexible porous membrane.
